(19) United States
(12) Patent Application Publication
(10) Pub. No.: US 2015/0046344 A1
(43) Pub. Date: Feb. 12, 2015

(54) Method of creating value from intangible assets

(71) Applicant: Omar B. Hakim, Austin, TX (US)

(72) Inventors: Omar B. Hakim, Austin, TX (US); George Poletes, Dallas, TX (US)

(21) Appl. No.: 10/890,462

(22) Filed: Jul. 12, 2004

Related U.S. Application Data
(60) Provisional application No. 60/486,004, filed on Jul. 10, 2003.
(60) Provisional application No. 60/486,066, filed on Jul. 10, 2003.

(51) Int. Cl. G06Q 50/18; G06Q 30/02

(52) U.S. Cl. CPC G06Q 50/184; G06Q 30/0283
USPC 705/310

(57) ABSTRACT

A computer-implemented method, including storing information regarding a plurality of patents, where information regarding at least one patent of the plurality of patents is transmitted from a communication device of or associated with a patent rights holder and storing information regarding a pool of patents, where the pool of patents includes at least two patents of the plurality of patents. The method also includes storing information regarding a price to obtain a license to the pool of patents and receiving a request for information for obtaining the license to the pool of patents, where the request for information is transmitted from a third-party. Also, the method includes processing the request for information for obtaining the license to the pool of patents with a processor, generating a message in response to the request, where the message contains at least one term or condition and a price, and transmitting the message.

### CROSS-REFERENCE TO RELATED APPLICATIONS

This application claims priority benefit to U.S. Provisional Application Ser. Nos. 60/486,004 filed on Jul. 10, 2003 and 60/486,066 filed on Jul. 10, 2003 by inventors Omar Hakim and George Poletes. This application is also related to U.S. Ser. No. 10/______, filed on Jul. 12, 2004 [Attorney Docket No. 41770-P001US] by the same inventors which is incorporated herein by reference.

### STATEMENT REGARDING FEDERALLY SPONSORED RESEARCH/DEVELOPMENT

Not Applicable.

### TECHNICAL FIELD OF THE INVENTION

This invention generally relates to a method for creating value from intangible assets and in particular to a method for producing revenue from underutilized intellectual property, for example, patents, trademarks or copyrights.

### BACKGROUND OF THE INVENTION

Without limiting the scope of the invention, its background is described in connection with patents, trademarks, copyrights and other intellectual property and is best exemplified by methods for exploiting underutilized intellectual property.

The United States Patent and Trademark Office (USPTO) and foreign patent offices around the world issue thousands of patents each year. Corporations and educational institutions are among the organizations that file the largest number of applications to register intellectual property rights in their inventions. These inventions may be the culmination of substantial research and development efforts and funds. Naturally, these organizations are interested in recouping some, if not all of the expenditures for procuring patents. Ideally, corporations and educational institutions would realize profits on their patents or other intellectual properties.

Intellectual property may generally be categorized into three groups: intellectual property of known value to the owner, intellectual property of unknown value to the owner and intellectual property of no value to the owner. Intellectual property of known value includes intellectual property that the organization uses regularly or technology that is a primary focus of their business or research. The value of the intellectual property may not be quantifiable, but the owner considers this intellectual property to be core to their mission and therefore not to be sold or transferred to others. For example, processes for genetic seed engineering may be a core technology of an agricultural college. The agricultural college may obtain a patent on the method of genetically engineering the seed to protect this core technology. The college may actively use or license this patented technology daily and therefore, the seed patent is actively utilized to protect the core technology.

Intellectual property of unknown value may have been developed by accident or it may have been a technology that the company or university had explored but decided not to pursue. Intellectual property of unknown value may also be obtained to build assets for the organization. As an example, the agricultural college may have accidentally discovered a new and useful process for manufacturing textiles during their agricultural research. The agricultural college may obtain a patent to protect this process but eventually never exploit the patented technology. It is likely that intellectual property may simply be unused until the expiration of the intellectual property rights. Additionally, intellectual property of unknown value may be obtained for defensive purposes, e.g., to defend against an infringement lawsuit by providing potential infringement counterclaims.

Intellectual property of no value is intellectual property that has no more commercial or other value to its owner. For example, a semiconductor company may patent a manufacturing process that is then abandoned by the company several years later in favor of a new and better manufacturing process. The abandoned patent may have many years of life before it expires, but it is no longer of value to the original patent holder.

In these instances, the intellectual property is not actively used but will still cost the organization over its lifetime. These costs, which include application preparation, filing fees, prosecution costs and maintenance fees, can amount to a significant sum for the organization. The organization may also incur significant costs to manage its intellectual property portfolio. Furthermore, if an organization procures and maintains corresponding foreign intellectual property, costs also increase significantly.

Therefore, what is needed is a method of managing intellectual property rights that does not allow rights to expire without having value during their lifetime.

### SUMMARY OF THE INVENTION

The present invention includes a system and method of creating value from intangible assets. The method has the steps of soliciting one or more licenses, assignments or other conveyance vehicles to one or more underutilized intangible assets from one or more owners of the underutilized intangible assets. The one or more licenses to the one or more underutilized intangible assets are then accepted into a pool. One or more rights to the one or more underutilized intangible assets are then conveyed to another party, thereby creating value for the one or more underutilized intangible assets.

### BRIEF DESCRIPTION OF THE FIGURE

For a more complete understanding of the present invention, including its features and advantages, reference is now made to the detailed description of the invention taken in conjunction with the accompanying drawing in which:

FIG. 1 is a schematic diagram of a valuation system according to one embodiment of the present invention;

FIG. 2 is a flow diagram of a valuation system according to one embodiment of the present invention;

FIG. 3 is a block diagram depicting a computer system according one embodiment of the present invention; and

FIG. 4 is a flow diagram of a valuation system according to one embodiment of the present invention.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

As discussed above, many organizations have expended significant resources to secure rights to various intellectual properties. Some of this intellectual property is actively used to generate revenues and protect business operations. Some intellectual property is unused or underutilized and consumes more funds for management and maintenance fees than the intellectual property generates.

Intellectual property is inherently difficult to valuate for many reasons. Real property, by contrast, may be valued by comparing a property to similar properties in a particular location and assigning a value to the property according to sales prices of the similar properties. Patents in a particular technology, conversely, may be significantly unique and not have truly similar counterparts with which to compare. Additionally, even if comparable patents are identified, sales or valuation data for these patents may not be available. An owner of unused or underutilized intellectual property, therefore, may have no notion of the value of a particular piece of intellectual property, aside from the cost of procuring the rights in the property. The owner often knows if the intellectual property is of value, has no value or is of unknown value to themselves, but they often have little or no idea if this same intellectual property would have value to others.

The present invention provides a mechanism for owners to gain value from an intangible asset. An intangible asset could be anything that is difficult to valuate. This detailed description, however, will generally describe the present invention with reference to intellectual property and, in particular to unused or underutilized patents, although the invention could be applicable to copyrighted works (e.g. music, written works, films, etc.) and to trademarks of unknown or no value to its owners. Value is created by first acquiring rights or options for rights in underutilized patents from an owner and placing these rights into a pool. The pool of rights may then be marketed to other parties or organizations that are interested in gaining access into a particular field of technology or mining the pool for possibly valuable and overlooked rights. This pool may also offer rights to fractional elements of the intellectual property. For example, specific patent claims may be assigned to the pool, or specific scenes from a copyright protected movie, or specific musical elements from a copyright protected song.

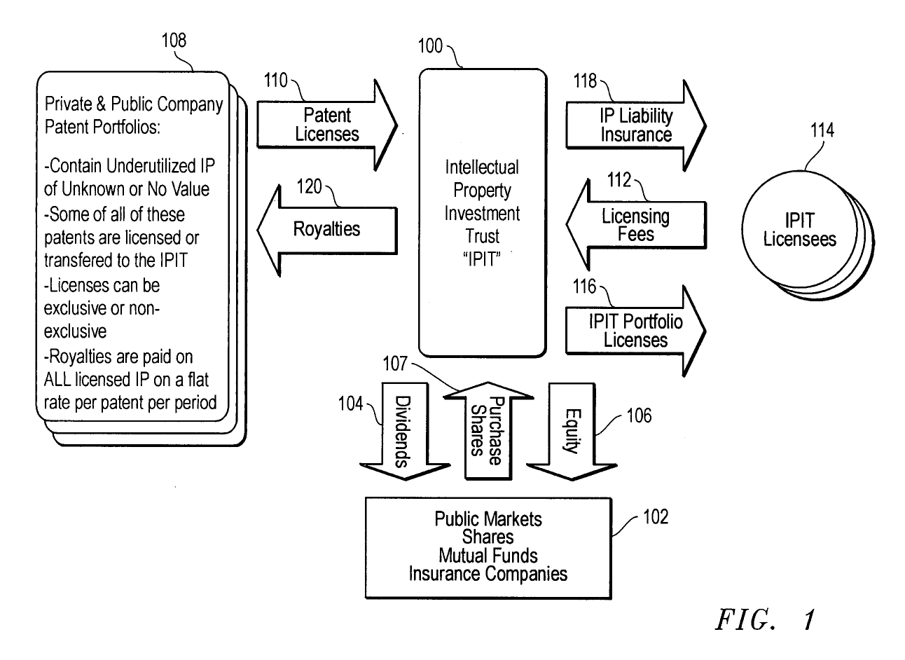

Turning now to FIG. 1, a schematic diagram of the present invention is depicted. In this particular embodiment intellectual property is licensed to an Intellectual Property Investment Trust (“IPIT”) 100, which may be licensed to third parties. The IPIT 100 may be a privately held company that generates cash flow for the owners 102 or the IPIT 100 or a public company that will pay a dividend 104 and generate value for its owners via equity appreciation 106. The owners 102 purchase shares 107 of the IPIT 100 and drive profit as described above. The IPIT 100 may also be a mutual fund that pays dividends to its owners 102, or the IPIT 100 may be created and held by an insurance company in order to generate annuity revenue streams.

Patents licensed to the IPIT 100 may be organized according to various areas of technology, such as chemistry, biology, genetics, mechanics or agriculture, for example. The IPIT 100 contains the rights to these underutilized or unused patents. Patents are licensed to the IPIT 100 by their owners. The licenses are preferably exclusive, although non-exclusive licenses may also be acquired.

It is anticipated that IP owners 108 will license patents 110 of unknown value or worthless patents to the IPIT 100, although other patents may also be licensed 110 to the IPIT 100. Patents of unknown value are often procured during the course of research and development work. No commercialization efforts, however, may have been conducted to determine their value. Alternatively, worthless patents no longer have value to the current owners. These patents are often patents for production techniques or technologies that are no longer being used or made by the patent holder. Sometimes these patents still have a long term before expiration.

Patents of unknown or no value are a primary target for licensing to the IPIT 100. These patents could represent almost half of all patents within a large organization's patent portfolio. Because these patents are not being used by the IP owners 108, the risk of licensing to the IPIT 100 is relatively low and there is little disincentive to license 110 these patents. Additionally, these patents are a financial liability to the IP owners 108 because of maintenance fees and management costs.

Each patent licensed to the IPIT 100 generates a small licensing fee 112 each time the IPIT 100 patent pool is licensed. Although these licensing fees 112 may be relatively small, they create a positive cash-flow revenue stream 120 for the IP owner 108 rather than simply being a liability. The IP owner 108 sees increased revenue from the IPIT 100 according to the number of licensed patents because revenues may be based upon the number of patents licensed to the IPIT 100.

IPIT licensees 114 receive a non-exclusive license 116 to the entire IPIT 100 pool of patents. IPIT licensees 114 are maintained within a database of licensees and all licensees may be notified as to the identity of all of the other licensees. A cross licensing agreement may contain a contractual agreement that licensees will not sue other licensees for patent infringement if the potential infringement suit includes patents from the IPIT 100 patent pool. Patents within the patent pool can be treated as “public domain” IP for all IPIT licensees 114, which allows IPIT 100 patent pool licensees to use technology protected by IPIT 100 patents within their own new proprietary products, services and processes.

Each IPIT licensee 114 may receive a patent infringement liability insurance policy 118 with their IPIT 100 cross-licensing agreement. The insurance policy 118 may cover the IPIT licensee's 114 legal fees and liability protection up to a particular amount. The policy may cover legal action between fellow IPIT licensees 114 as well as legal action from non-IPIT licensees. As a result, intra-IPIT legal action will be minimized by the contractual clause(s) within the IPIT 100 cross-licensing agreement. These clauses can include a provision for binding arbitration to settle any intra-IPIT related disputes between IPIT licensees.

Additionally, the insurance policy 118 may cover legal action from external non-IPIT entity. One purpose of the liability insurance protection is to create a large “group plan” for defending and protecting the IPIT 100 intellectual property and the IPIT licensees 114. The liability insurance policy 118 may cover each member of the IPIT 100 patent pool. The liability insurance policy 118 may also cover any legal action initiated by the IPIT (by the request of its members) 100 to protect the patents within its patent pool from infringement by non-IPIT members.

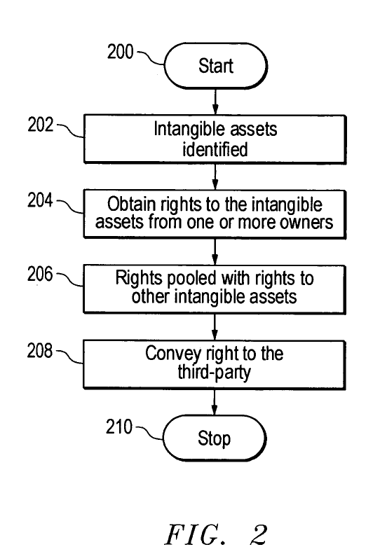

Referring now to FIG. 2, a flow diagram is shown. The process begins with Start 200. Next, in step 202, the intangible assets are identified. The intangible assets may relate to a particular industry or to a class of products or services. The intangible assets may also lie outside the line of business or use of an asset holder that owns the intangible asset or that has a right to convey a license to the intangible asset. Outside the line of business or use is any service or goods provided by the business other than those which constitute the business' primary goods and/or services. The intangible assets include, but are not limited to trademarks, copyrights and patents.

In step 204, the right in the intangible asset is obtained from the asset holder. The asset owner may own the intangible asset or have the right to convey a license to the intangible asset. The asset holder may assign the right, provide an exclusive license to the right, or provide a non-exclusive license to the right. In one disclosed embodiment, a set of standardized or predetermined terms and conditions are used to reduce the necessity for negotiation and to reduce the overall costs. The right obtained may include the right either to convey a license to the intangible asset to a third-party or to facilitate, as an agent of the asset holder, conveyance of a license to the intangible asset to a third-party. The value of the right obtained may vary. The actual or perceived transaction cost of negotiating transfers of the rights in an individualized manner may exceed the actual or perceived benefit of consummating the transfers.

In step 206, the obtained rights are pooled with rights in other intangible assets acquired from one or more other asset holders. Multiple pools may be formed, where intangible assets that relate to said industry or class of products or services are combined together. The intangible assets in a specific pool may relate to a variety of different products or services within a specific industry or class of products or services. The specific pools may be created based upon the industry or class of products or services defined by a Standard Industrial Classification (SIC) number or by a North American Industry Classification System (NAICS) number or defined by the patent class or subclass as promulgated by the United States Patent and Trademark Office (USPTO) Office of Patent Classification.

Next, in step 208 the right is conveyed to the third-party. In this embodiment, the conveyance is accomplished under a third set of standardized or predetermined terms and conditions which provides a non-exclusive license to all rights in the IPIT Pool. Again, multiple third parties may obtain the rights from the pool. In one disclosed embodiment, the amount of consideration paid by a third-party to exercise the option for a particular right is independent of the extent to which the third-party exploits that particular right. Specifically, no per use based royalty is applied, only a flat fee to exploit the patent technology. The process ends with stop 210.

In one disclosed embodiment, the IPIT is a method of licensing a group of technologies as a pool, where the cost of licensing is a fixed fee times the number of technologies that are in the pool. Most patent pools are used to cluster patents and technologies to support a specific technology application (i.e. the DVD Patent Pool that clusters 43 DVD-related patents into one pool). The IPIT is a pool of broadly related patents and technologies that enables pool licensees to use any or all of the technologies within the IPIT without having to negotiate separate licensing agreements.

The IPIT pool licensing agreement applies to all technologies within the pool. This is a key business method for enabling the biotech and nanotech industries, since many of the technologies that would be contained within the IPIT would relate to small-scale fabrication technologies. Pool licensees would be free to utilize any or all of the pooled technologies within their R&D environments (but not for mass-production or commercial purposes). This promotes trial-and-error and multiple concurrent development projects within these R&D departments so they do not have to delay their R&D efforts in order to find new technologies and then negotiate a research license. The IPIT provides a “one-to-many” licensing approach that frees the technology owners from negotiating separate licensing agreements with each licensee.

In one disclosed embodiment, the IPIT identifies a patent that relates to a particular industry. Under a first set of predetermined terms, the IPIT obtains a right in the patent from a “patent holder” who possesses at least a right to convey a license to the patent. The obtained right includes at least the right to facilitate conveyance of a license to the patent to a third-party. The IPIT pools the obtained right together with other rights in patents acquired from one or more other patent holders, thereby forming a pool of rights in patents that relate to the particular industry. Under a second set of predetermined terms, the IPIT then conveys, or facilitates conveyance, to a third-party of a non-exclusive license to all rights in the pool.

As used herein, the term “particular industry” refers to an industry, sub-industry or line of business that makes, sells or uses a particular class or subclass of products, processes or services. When a patent holder “possesses at least a right to convey a license to the patent,” the patent holder may own the patent outright or may merely possess the right to sublicense all or partial rights in the patent. A “set of predetermined terms” refers to a set of terms and conditions that is standardized and uniform in comparison to the terms and conditions applied to other patents in the pool. Preferably, the terms and conditions are predetermined in a uniform manner that applies to all or substantially all patents in the pool. More preferably, the consideration paid to the patent holder and/or the consideration payable by the third-party is predetermined in accordance with a formula that applies to all like patents in the pool. Most preferably, the consideration can be calculated by a computer or in an otherwise automated or rote manner.

Except where stated otherwise, the phrase “at least the right to facilitate conveyance of a license to the patent to a third-party” means that the minimum right obtained by the IPIT is the right to facilitate such conveyance as an official or de facto agent of the patent holder. The IPIT may have much greater rights. For example, if the IPIT obtained an assignment from the patent holder, the IPIT may own the patent outright. Alternatively, the IPIT may, for example, have obtained an exclusive license from the patent holder. Except where indicated otherwise, the phrase ‘facilitating conveyance’ includes direct conveyance of a patent owned or licensed by the IPIT itself as well as the facilitation of conveyance as an agent of or as a service to a patent holder

With regard to a plurality of the patents in the pool, the transaction cost of negotiating transfers of rights to each patent in an individualized manner may exceed the benefit of consummating the transfers in an individualized manner. More preferably, this is true for a majority of patents in the pool. Still more preferably, this is true for substantially all of the patents in the pool. Except where stated otherwise, the term “transaction cost” refers to (1) the actual transaction cost for either or both the patent holder and the third-party or (2) the transaction cost perceived by either or both the patent holder and the third party. Likewise, except where stated otherwise, the term “benefit” refers to the actual benefit to, or the benefit perceived by, either or both the patent holder or the third-party. Negotiating the transfer of a patent right in an “individualized manner” refers to negotiating for the transfer in a patent-by-patent or face-to-face manner. In other words, such transfers entail bargaining, deliberation or back and forth communication between people who represent the parties.

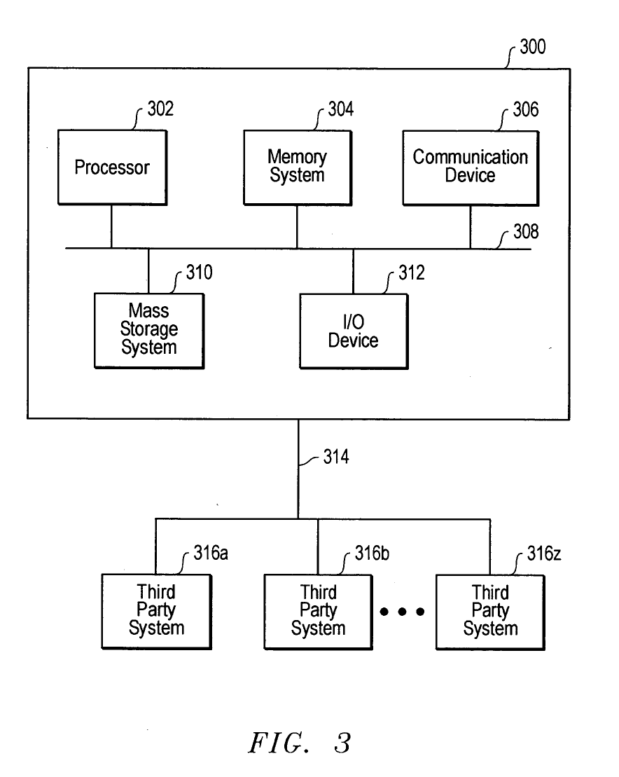

Referring now to FIG. 3, a computer system according to one embodiment of the present invention is shown. A computer system 300 is shown including a processor 302, a memory system 304, a communication device 306, a mass storage device 310, and an I/O device 312, all connected via bus 308. The communication device 306 includes an Internet communication device which allows the computer system 300 to be connected to the Internet via any Internet connection 314, including standard phone lines, direct connection or wireless connection.

The processor 302 includes processors commonly known to those skilled in the art and which are commonly available. The memory system 304 includes random access memory (RAM) and read-only memory (ROM). The bus 308 includes buses commonly know to those skilled in the art and which are commonly available. The mass storage system 310 includes a hard disk drive, a read/write CD drive, an optical drive, tape drive, or a removable drive. The mass storage system 310 must be of sufficient size to store a database of records related to the obtained patent rights, such database including, but not limited to, identity of patent holder, patent, patent industry, licensee fee, royalty fee, patent expiration. The I/O device 312 includes a keyboard and mouse among others. The I/O device 312 allows for the input and output of data to the computer system 300. IPIT software is resident in the memory system 304 or the mass storage system 310 and is executable by the processor 302.

The computer system 300 is connected to third party computer systems 316a-z via the internet connection 314. The third party computer systems 316a-z include, but are not limited to patent holders, IPIT licensees, patent fee service companies, and patent databases such as the patent database at the United States Patent and Trademark Office and the Delphion patent database.

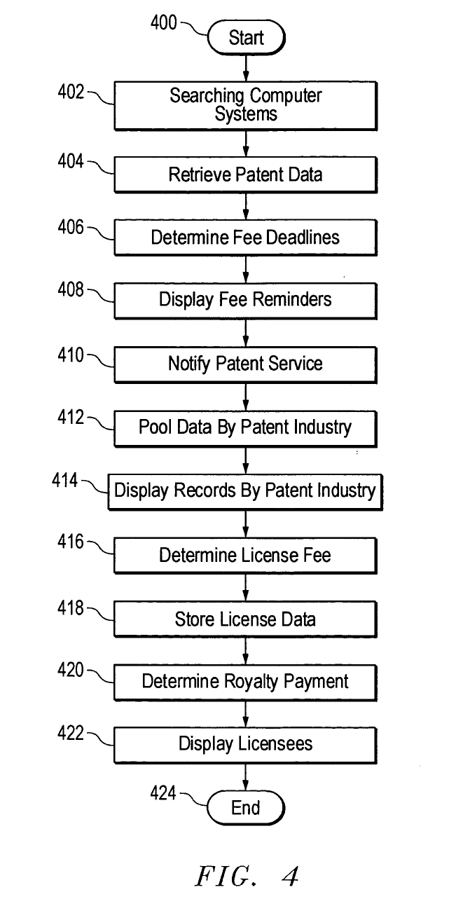

Referring now to FIG. 4, a flow chart depicting the IPIT method is shown. The method begins with Start 400. In step 402, third party computer systems are searched. Based upon the patent rights obtained from the patent holder, inventor specific or patent specific data is searched for on the third party computer systems. In one disclosed embodiment, this search is conducted on a predetermined period, such as once a week. Third party computer systems such as the United States Patent & Trademark Office and Delphion are searched. A search of all patent is conducted with any additional or new information be identified. Next, in step 404, the data identified during the search is downloaded. The full text, including description and claims, and drawings of the particular patent is downloaded and viewable. Maintenance fee and patent family history is also downloaded and associated with the records related to the particular patent or patent holder.

Next, in step 406, future maintenance deadlines for the particular patent are calculated and stored with the records related to the particular patent. In step 408, the future maintenance fee deadlines are displayed to individuals reviewing the records for a particular patent. Next in step 410, a predetermined patent maintenance fee service is notified regarding the particular patent. Upon agreement from the patent holder, the maintenance fee service is automatically notified prior to the expiration of the particular patent regarding instructions for payment of the necessary fees. The cost of the fees is then noted in the records and deducted from any royalty payments due to the patent holder.

Next, in step 412, the records of a particular patent industry are pooled. The records of all the patents in the particular industry are grouped and combined and associated with the particular industry. In step 414, the pooled group is displayed. A third party accesses the IPIT computer system and selects a particular industry. Once selected, the records relating to the patents in that particular industry are viewable. The third party may access the IPIT computer system through a direct connection or through an Internet connection. Further, the records relating to the patents in a particular industry may be downloadable. This feature may be limited to a subset of all third parties, specifically, the downloadable feature may only be available to licensed IPIT users.

In one embodiment, IPIT licensees have access to information of the patent holders, including the availability of prototypes or the availability of expert consulting. Contact information for the patent holders is also available or a blind email may be provided. Additional technology or equipment related to the particular patent of the patent holder may be listed in the records along with conditions for rental or purchase. Automated rental request of technology, equipment or prototypes may also be included. Fees collected may be combined and accounted for automatically.

Next, in step 416, the license fee for the patent pool is determined. The quantity and quality of the patent rights contained within a particular patent industry are evaluated with a standard license fee calculated based upon predetermined factors, including, but not limited to, remaining term of patent and breadth of claim coverage. Once the particular patent industry pool is licensed, the licensed data is stored with the records related to the particular patents in the particular industry in step 418. Next, in step 420, the royalty payments to the patent holders for the patents related to the particular industry are determined. The royalty amounts are controlled by the first set of predetermined terms and conditions and are triggered upon the entry of an IPIT license for the particular industry. In step 422, the licensees of a particular industry and displayed to other licensees and third parties. Once a licensee ceases payment, the licensee is removed from the IPIT list and all remaining IPIT licensees are notified. The method ends with 424.

In one disclosed embodiment, patents would be removed from the database as they expire. The removal could be automated and notice to the IPIT licensees and patent holders can be automatically sent. Further, new patents to a patent holder may be included if the patent right obtained requires such action. In one disclosed embodiment, financial, accounting and auditing capabilities are available for IPIT licensees and patent holders.

In one disclosed embodiment, the IPIT includes the collecting and organizing of patents into patent pools based upon their field-of-use, including, but not limited to SIC codes. The IPIT monitors the patent databases to determine when patents of interest would be expiring due to failure to pay maintenance fees. The patent owners may no longer want to pay the necessary maintenance fees but may desire to derive some benefit from the expiring patent. In one disclosed embodiment, the IPIT automatically monitors the patent databases and upon the discovery of an expiring patent or a recently expired patent, automatically contacts the patent owners. The IPIT may automatically contact the patent owners via electronic mail, facsimile or through the generation of a printed letter. The IPIT may also automatically identify the candidate patents to IPIT administrators for manual follow-up action.

The IPIT obtains from the patent owners the rights, including ownership, of the patents about to expire or recently expired. The IPIT obtains the patent rights for a reduced royalty based upon IPIT agreement to pay the maintenance fees. The IPIT then re-licenses this pool of industry-specific patents (that had almost expired) to other entities within the same industry or field-of-use in order to help them reduce their freedom-to-operate search costs and to reduce their potential of patent infringement lawsuits. The patent owners don't perceive these patents as having any value, so they allow these patents to expire rather then maintain them. The IPIT offers these patent owners a royalty (based upon the royalty stream of the IPIT) for these otherwise discarded patents. The IPIT pays royalties to the patent owners after the IPIT has recovered any of the maintenance fees that were paid on behalf of the patent owners.

Although this invention has been described with reference to an illustrative embodiment, this description is not intended to limit the scope of the invention. Various modifications and combinations of the illustrative embodiments as well as other embodiments of the invention will be apparent to persons skilled in the art upon reference to the description. It is therefore intended that the appended claims accomplish any such modifications or embodiments.

1-87. (canceled)

88. A computer-implemented method of pooling patents for reducing, at least one of, litigation exposure and freedom to operate costs, comprising:
executing commands by one or more processor to perform steps including:
obtaining a right in at least one patent owned by a first entity;
pooling said obtained right in at least one patent with at least one right obtained in at least a second patent owned by a second entity to form a pool of patents in a related field;
displaying an indication of said pool of patents;
determining a price to obtain a license to said pool of patents based upon at least one of a set of predetermined terms for said license, wherein said price is a standardized flat fee determined independently of the extent of usage of said pool of patents by a licensee; and
storing said price on a storage device.

89. The computer-implemented method of claim 88, wherein the step of pooling said obtained right in at least one patent with at least one right obtained in at least a second patent to form a pool of patents in a related field, further comprising:
forming at least one group of patents from said pool of patents based on at least one criteria.

90. The computer-implemented method of claim 89, further comprising:
determining a price to obtain a license to said at least one of group of patents based upon a valued derived from a set of predetermined terms for said license times the number of said at least one group of patents.

91. The computer-implemented method of claim 88, further comprising:
receiving a request for information for obtaining said license to said pool of patents with a receiver from a third party inquiring about obtaining said license transmitted from a communication device of or associated with said third-party.

92. The computer-implemented method of claim 88, wherein a perceived transaction cost of negotiating the license for said pool of patents exceeds a perceived benefit of obtaining the license for the pool of patents.

93. The computer-implemented method of claim 88, wherein an actual transaction cost of negotiating issuing a license for said pool of patents exceeds an actual benefit of obtaining a license to said at least one patent of said pool of patents.

94. The computer-implemented method of claim 88, wherein the plurality of patents pertain to a product, products, service, or services within a field, industry, or classification.

95. The computer-implemented method of claim 94 wherein the field, industry, or classification, is defined by a Standard Industrial Classification (SIC) number or by a North American Industry Classifications System (NAICS) number.

96. The computer-implemented method of claim 94, wherein the field, industry, or classification is defined by a patent class or subclass as promulgated by the United States Patent and Trademark Office Classification System.

97. The computer-implemented method of claim 88, further comprising:
offering a license to said pool of patents as a non-exclusive license.

98. The computer-implemented method of claim 88, further comprising:
receiving a request for information for obtaining a cross-license to said pool of patents, wherein the request for information for obtaining a cross-license is transmitted from a communication device of or associated with a third-party.

99. The computer-implemented method of claim 98, further comprising:
offering a cross-license to said pool of patents.

100. The computer-implemented method of claim 99, further comprising:
offering a cross-licensee third-party immunity from being sued by another third-party who has a license to said pool of patents.

101. The computer-implemented method of claim 88, further comprising:
offering patent infringement liability insurance policy for protecting each third-party licensee from an infringement lawsuit by another third-party licensee.

102. A computer-implemented method of pooling patents for reducing, at least one of, litigation exposure and freedom to operate costs, comprising:
executing commands by one or more processor to perform steps including:
obtaining rights in a plurality of patents in a related field;
forming at least one pool of patents with at least one patent from said plurality of patents in a related field based on at least one criteria;
displaying an indication of said plurality of patents;
determining a price to obtain a license to at least one of said plurality of patents in a related field based on a fixed fee times the number of said pools to be licensed, wherein said price is determined independent of the extent of usage of said pools by a licensee; and
storing said price on a storage device.

103. The computer-implemented method of claim 102, further comprising:
determining said fixed fee based upon at least one of a set of predetermined terms for said license.

104. The computer-implemented method of claim 102, wherein said price is determined independently of usage of at least one patent in said pool of patents by a licensee.

105. The computer-implemented method of claim 102, wherein said price is determined independently of a valuation of said at least one patent based on its unique characteristics.

106. The computer-implemented method of claim 102, further comprising:
receiving a request for information for obtaining said license to said pool of patents with a receiver from a third party inquiring about obtaining said license transmitted from a communication device of or associated with said third-party.

107. The computer-implemented method of claim 102, wherein a perceived transaction cost of negotiating the license for said at least one patent of said pool of patents exceeds a perceived benefit of obtaining the license for the pool of patents.

108. The computer-implemented method of claim 102, wherein an actual transaction cost of negotiating issuing a license for said at least one patent of said pool of patents exceeds an actual benefit of obtaining a license to said at least one patent of said pool of patents.

109. The computer-implemented method of claim 102, wherein the plurality of patents pertain to a product, products, service, or services within a field, industry, or classification.

110. The computer-implemented method of claim 109, wherein the field, industry, or classification, is defined by a Standard Industrial Classification (SIC) number or by a North American Industry Classifications System (NAICS) number.

111. The computer-implemented method of claim 109, wherein the field, industry, or classification is defined by a patent class or subclass as promulgated by the United States Patent and Trademark Office Classification System.

112. The computer-implemented method of claim 102, further comprising:
offering a license to said pool of patents as a non-exclusive license.

113. The computer-implemented method of claim 102, further comprising:
receiving a request for information for obtaining a cross-license to said pool of patents, wherein the request for information for obtaining a cross-license is transmitted from a communication device of or associated with a third-party.

114. The computer-implemented method of claim 113, further comprising:
offering a cross-license to said pool of patents.

115. The computer-implemented method of claim 114, further comprising:
offering a cross-licensee third-party immunity from being sued by another third-party who has a license to said pool of patents.

116. The computer-implemented method of claim 102, further comprising:
offering patent infringement liability insurance policy for protecting each third-party licensee from an infringement lawsuit by another third-party licensee.

117. A system for pooling patents for reducing, at least one of, litigation exposure and freedom to operate costs, comprising:
a storage device, wherein the storage device stores information regarding obtained rights in at least one patent, information regarding a pool of said obtained rights in at least one patent with at least one right obtained in at least a second patent to form a pool of patents in a related field, and information regarding a price to obtain a license to said pool of patents;
a processor, wherein the processor presents for display an indication of said pool of patents and further determines said price to obtain a license to said pool of patents based upon at least one of a set of predetermined terms for said license, wherein said price is wherein said price is a standardized flat fee determined independently of the extent of usage of at least one patent in said pool of patents by a licensee; and
a receiver, wherein the receiver receives a request for information for obtaining said license to said pool of patents with a receiver from a third party inquiring about obtaining said license transmitted from a communication device of or associated with said third-party.

118. The system of claim 117, wherein a perceived transaction cost of negotiating the license for said at least one patent of said pool of patents exceeds a perceived benefit of obtaining the license for the pool of patents.

119. The system method of claim 117, wherein an actual transaction cost of negotiating issuing a license for said at least one patent of said pool of patents exceeds an actual benefit of obtaining a license to said at least one patent of said pool of patents.

120. The system of claim 117, wherein the plurality of patents pertain to a product, products, service, or services within a field, industry, or classification.

121. The system of claim 120, wherein the field, industry, or classification, is defined by a Standard Industrial Classification (SIC) number or by a North American Industry Classifications System (NAICS) number.

122. The system of claim 120, wherein the field, industry, or classification is defined by a patent class or subclass as promulgated by the United States Patent and Trademark Office Classification System.

123. The system of claim 117, further comprising a transmitter, said transmitter transmitting a message containing an offer of a license to said pool of patents as a non-exclusive license.

124. The system of claim 123, wherein said message further comprising an offer of patent infringement liability insurance policy for protecting each third- party licensee from an infringement lawsuit by another third-party licensees.

125. The system of claim 117, further comprising said receiver receiving a request for information for obtaining a cross-license to said pool of patents, wherein the request for information for obtaining a cross-license is transmitted from a communication device of or associated with a third-party.

126. The system of claim 117, further comprising said transmitter transmitting a message containing an offer to a cross-license to said pool of patents.

127. The system of claim 126, wherein said message contains an offer for cross-licensee third-party immunity from being sued by another third-party who has a license to said pool of patents.
